(19) United States
(12) Patent Application Publication
(10) Pub. No.: US 2011/0106796 A1
(43) Pub. Date: May 5, 2011

(54) SYSTEM AND METHOD FOR RECOMMENDATION OF INTERESTING WEB PAGES BASED ON USER BROWSING ACTIONS

(76) Inventor: Marko Svaic, (US)

(21) Appl. No.: 12/608,922

(22) Filed: Oct. 29, 2009

(51) Int. Cl. G06F 3/048; G06F 17/30

(52) U.S. Cl. 707/728; 715/760; 707/E17.109

(57) ABSTRACT

Recommended Web sites are presented in response to a user visit to a Web site, a history of previous user visits to Web sites, or a user-initiated search query. The Web sites that are recommended are those deemed most similar to the subject Web site or to the results of the search query, as appropriate. Information regarding Web sites is retrieved from locations within a distributed system as identified by a distributed hash table and similarity assessments between the subject Web site or query responses and those Web pages may be made according to that information, as periodically updated.

### FIELD OF THE INVENTION

The present invention provides systems and methods for recommending content stored on computer systems interconnected by one or more networks and accessible through graphical user interfaces such as the World Wide Web.

### BACKGROUND

The Internet is a vast and expanding network of computer systems and other devices linked together by various communications media, enabling these computer systems and other devices to exchange and share data. Content available on the computer systems (often called “hosts”) which make up the Internet provides information about a myriad of companies, people and products, as well as educational, research and entertainment information and services. All hosts accessible through the Internet have an associated address (often expressed in the form of a Uniform Resource Locator or URL), which allows each host to be uniquely identified and located.

A graphical user interface, the World Wide Web or simply the “Web”, provides means for users to view the hosted content using specialized computer programs called Web browsers. A browser runs on a user's local computer system (which may be a personal computer or handheld device, mobile phone, etc.), and receives from a host instructions which inform the browser how to present or render content retrieved from the host (or other computer resource). Such presentations often take the form of “Web pages”, and a collection of Web pages organized under a common Internet address is often referred to as a Web site.

Many Web sites and portals (which may be regarded as Web site that aggregate information from other Web sites in a common manner—more recent portals include features for user-specified patterns of aggregation) include recommender systems—that is, means for filtering information from a variety of hosts and other resources in a manner thought to be of likely interest for a particular user or class of users. Often, such recommender systems have detailed information regarding the user (e.g., in the form of a user profile) and make recommendations concerning content by comparing that user information to some reference characteristic of a plurality of Web sites. The information about users in user profiles can be obtained from their behavior on the site or from other kinds of activities off the site, for example, histories of purchases from e-commerce sites or histories of viewed movies from online DVD rental sites. Recommender systems are used for many purposes, such as presenting to users opportunities for reviewing potentially interesting new content available through one or more Web sites, and suggesting items for purchase.

One example of a content recommendation system is StumbleUpon™, a recommendation system that uses social networking concepts to display Web pages thought to be of interest to a user. Recommendations may be based on the user's ratings of previously viewed Web pages, ratings provided by the user's “friends” (as defined by the user), and ratings provided by users with similar interests to the subject users (as determined by comparisons of information included in the various users' profiles). In particular, users rate pages they like and which are clustered in categories. Clusters of pages which have been rated interesting in certain categories by a large group of users can then be used as a basis for recommending new pages from such clusters.

### SUMMARY OF THE INVENTION

In one embodiment, recommended Web sites are presented in response to a user visit to a Web site, a Web history of previous visits to a Web site, or a user-initiated search query. The Web sites that are recommended are those deemed most similar to the subject Web site or to the results of the search query, as appropriate. Information regarding each of the recommended Web sites is retrieved from a data structure stored at a location within a distributed system identified by a distributed hash table. Similarity between the subject Web site or query responses and various Web pages may be estimated according to a scalar product of vectors representing the subject Web site or query response and each respective Web page. These vectors are updated, for example in response to user visits to the associated Web pages and according to maturity factors associated with each respective user that visits the respective Web page. The user visits may include references by virtual users and/or ratings by oracles. In another embodiment of the invention, information regarding recommended sites is stored in a hybrid data structure consisting of a distributed system and a centralized system that includes multiple computers connected through a local network.

Similarity between Web pages may be assessed each time an individual user visits a page and data structures stored in the distributed system may be updated to reflect these assessments. These assessments may make use of history information regarding user browsing activities and/or category information associated with each Web page and may be performed for Web pages along routes defined within an undirected graph between computer systems that make up the distributed system.

These and further embodiments and features of the present invention are discussed in greater detail below.

### BRIEF DESCRIPTION OF THE DRAWINGS

The present invention is illustrated by way of example, and not limitation, in the figures of the accompanying drawings, in which:

FIG. 1 illustrates an example of a distributed system suitable for storing information at locations defined by a DHT in accordance with an embodiment of the present invention.

FIG. 2 illustrates an example of a computer system suitable for use in the distributed system shown in FIG. 1.

FIG. 3 illustrates an architectural view of the computer system shown in FIG. 2.

### DETAILED DESCRIPTION

Described below are new methods and systems for recommending Web pages based on user browsing actions.

In one embodiment of the present invention, a set of tuples, (user, page, rating, lime), is used to describe a user's interest in a particular Web page. Of course, information will exist only for a subset of every possible (user, page) pair, and ratings will typically be known only for a relatively small number of such pairs. Stated differently, it is not necessary for purposes of the present invention to have complete information regarding every possible (user, page) pair.

Values of the ratings can be measured in any of several ways. In its simplest form, a rating may be either 0 or 1, depending on whether the subject user has visited the page or not. Page visits can be tracked, for example, using a browser extension that monitors the URL of pages loaded in a user's Web browser.

In addition, ratings can be also calculated using information such as the time spent by a user viewing a subject page (which time can be monitored by the browser extension), preferences or interests explicitly stated by a subject user (e.g., as part of a user profile maintained by the browser extension or in a centralized server or in a distributed system based on a distributed hash table such as a distributed file system-based distributed hash table (DHTFS)), or preference or interest information derived from a subject user's Web browsing history (which may be compiled by the browser extension based on items such as number or frequency of visits, keywords in visited Web pages, bookmarking, etc.). Rating information for the (user, page) pairs is maintained and forms the basis for providing recommendations regarding Web pages that are likely to be of interest but which a subject user has not yet visited.

To provide meaningful recommendations, various correlations are important. Accordingly, we measure (a) the similarity between two Web pages, (b) associations between Web pages and users, and (c) similarities between pairs of users. In one embodiment of the invention, these measurements are achieved using a collaborative filtering methodology somewhat similar to singular value decomposition.

More particularly, to measure associations between Web pages and users, each user and each page is defined by a k-element vector, U for a user and V for a page, where k is a fixed constant. For each user and each page, U and V can be regarded as descriptions of the user's preferences and descriptions of the page's properties, respectively. That is, the values of the i^{th} elements of the user vector (Uᵢ) and the page vector (Vᵢ) represent how much the designated user likes the i^{th} property (or how important that property is to the user) and how much a particular Web page has (or is representative of) the i^{th} property, respectively. We can then estimate how much a particular user likes a particular Web page by calculating the dot (scalar) product of their vectors

$$( U \cdot V = {\sum }_{i} {U}_{i} {V}_{i} ) .$$

To measure similarities between pairs of pages or pairs of users, we perform a similar measurement between the two corresponding vectors (e.g., between U1 and U2 for users 1 and 2, respectively, and between V1 and V2 for pages 1 and 2, respectively).

The k-element vectors U and V may be formed as follows: Each time a user's rating of a page is obtained, the respective vectors are matched against each other and updated, so that the scalar product of the two vectors after each is updated is a successively closer approximation to the user's actual rating of the subject page than was the case before the vectors were updated.

Because pages and users can appear at any time (i.e., because new Web pages can be created and/or rated at any time and new users can agree to participate in or opt out of a system or service which provides the recommendations discussed herein at any time), it is desirable to avoid situations where new, unformed vectors influence already well-formed vectors. This is accomplished, in one embodiment of the invention, by associating a maturity number (or weight) with each vector. The maturity number is set to zero (0) initially, and each time a vector is matched against another the maturity number for the vector is increased by a small positive value, smaller than one (1), with the sum increasing towards one (1). The larger the maturity number, the greater the modification to the vector it modifies. In one embodiment of the invention, maturity is determined empirically as a fixed constant that, in the process of computing rating values, gives the best tradeoff between low maturities, which give well-formed pages slower influence but reduce rates of convergence, and high maturities, which give early vectors more influence in the process of convergence but can increase errors.

In one embodiment of the invention, the updating operation is performed as follows: For a given user vector U and page vector V, a random subset of U's indices is selected. Then, for each index j in that subset, Uⱼ is modified by an amount proportional to the difference between Uⱼ and Vⱼ and the maturity number of vector V. We make sure that Vⱼ stays within wanted bounds (e.g., −1 to 1, where −1 indicates a complete absence of a property and +1 indicates the property is fully encompassed or represented by the subject page) by trimming out of bound values. Thus, for a given U and V,

guess=U·V,

where • is a dot (scalar) product and “guess” is an estimate of the user's rating of the subject page (i.e., an estimate of how much the subject user likes the subject page)

err=rating−guess,

where rating is the user's actual rating of the subject page (obtained from user input via a browser extension, for example);

and the update is performed as follows:
for R random indices i,

Uᵢ=Uᵢ+[training_speed*signum(Vᵢ)*maturity(V)*err],
where training_speed is a damping factor, which may be selected empirically as a best tradeoff between a rate of convergence and a magnitude of the error, signum(Vᵢ) is defined as +1 for Vᵢ>0 and −1 for Vᵢ<0, and values of Uᵢ are trimmed if they are out of range;
   increase maturity(U); and
   perform a similar modification of vector V.

Given the vast number of web pages and users but the relatively small intersection between a particular Web page and an individual user, it is useful to have a seeding process to assist in establishing initial values for the user and page vectors. Hence, in one embodiment of the invention, “virtual users” can be used to speed up the vector forming process. Each virtual user has an associated set of pages that have something in common. For example, each blogroll of a certain blog is, almost by definition, a set of pages that the blogger responsible for the blog likes, hence, the blogger may be considered as a virtual user for purposes of rating the pages encompassed by the blogroll. Another example of a virtual user could be an RSS feed and the page links contained therein can be considered as having been rated by the feed.

In some instances, certain virtual users, called “oracles”, are considered to be so important that they should be permitted to rate any page. Examples of such oracles may be well-known Web portals such as Yahoo!™ and the like. Oracles are important for dealing with the cold start problem.

Cold start refers to the circumstance of a new page entering the system (i.e., a page which no user has previously rated). A new page will have no associated vector V, and so any attempt to determine how similar it is to other vectors would give a meaningless result. To deal with this issue, the present invention employs an “inverse triggering” strategy: Whenever a new page is encountered, various oracles are called or polled to rate it so that its initial vector can be formed in a relatively short period of time. This may be done, for example, by the above-mentioned browser extension sending a request for an oracle rating if a new page is loaded by the browser and no corresponding vector for that page can be located. Oracles can also be used as classifiers for various categories, hence, a rating that an oracle assigns to a page can be regarded as a measure of how well the page fits the category associated with the oracle (each oracle is preferably associated with only one category).

As alluded to above, in order to be used as part of the recommendation process the user and page vectors need to be accessible to the browser extensions or other computational engine responsible for providing the recommendations. In one embodiment of the invention, the page vectors are stored in a distributed system at storage locations defined by a distributed hash table-based distributed file system (DHTFS). Such locations may be distributed among a number of different computer systems communicatively coupled to one another through one or more networks.

A hash table is a function that uniformly and, often uniquely, maps strings to a range of numbers. The number to which a hash function maps a given string is called the key for that string. A distributed hash table (DHT) then, is a means for partitioning the space of all possible keys among a set of computers communicatively connected to one another through one or more networks. The DHT automatically routes messages to the computer responsible for a set of keys to which a given key belongs.

A distributed file system is a method for storing and organizing computer data on many computers connected through a network. An important characteristic of a distributed file system is that it presents a unified view to data and files stored on it such that all data can be accessed without regard to what particular computer, or plurality of computers, the data are actually stored on.

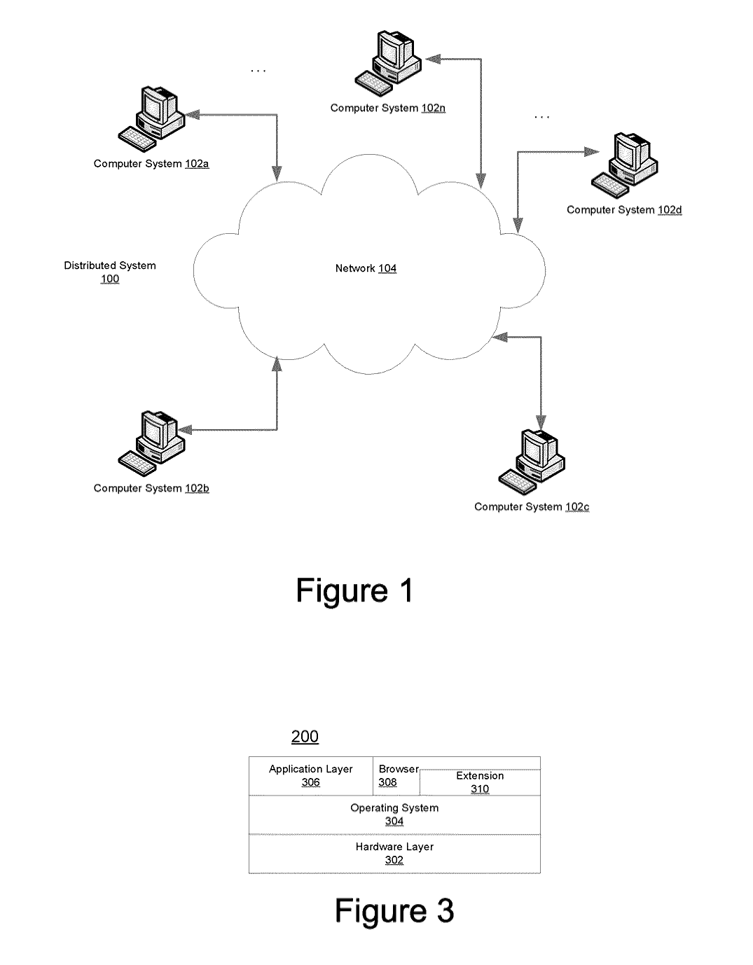

An example of a distributed system 100 suitable for storing information at locations defined by a DHT is illustrated in FIG. 1. Each computer 102a-102n is communicatively coupled via one or more networks 104 (such as the Internet) and can be responsible for storing various pieces of information. The storage space for the entire distributed system divided among computers 102a-102n using a DHT.

In an embodiment of the present invention, the page vectors are each stored as part of a larger construct called a url_tracker. Each url_tracker contains a variety of information about its subject page, e.g., a page identifier (urlID), the title of the page, keywords on the page, the rank of the page with respect to those keywords, etc. In addition, keyword_tracker structures that contain all URLs with the corresponding keyword in it are maintained. These trackers are distributed among and stored at computer systems 102a-102n, at locations defined by a DHT. More particularly, computer systems 102a-102n are used to store the url_trackers and keyword_trackers in a DHTFS, for example through the use of appropriately coded computer-readable instructions stored on computer-readable media and executed by computer processors associated with each computer system 120a-102n. The DHTFS stores this content across the address space defined by the storage devices of computer systems 102a-102n using the DHT keys as partitions for that address space and in practice the number of individual computer systems that make up distributed system 100 may be very large.

The storage and retrieval of content items from the DHTFS are facilitated through two principal kinds of messages:
put(key,value)
go(key)
   The DHT put message is used for storing an arbitrary sequence of bytes value under the key key. The DHT get message returns the last value stored in the DHT under a given key. Thus, each url_tracker can be encoded as a DHT put request to the hash corresponding to, for example, the URL of the page to which the url_tracker pertains. Similarly, keyword_trackers may be stored in appropriate locations. Creation of replicas of the stored trackers and synchronization among them may, in various embodiments of the invention, be handled by the underlying distributed file system as more fully discussed in a co-pending U.S. patent application entitled, “DHT-BASED DISTRIBUTED FILE SYSTEM FOR SIMULTANEOUS USE BY MILLIONS OF FREQUENTLY DISCONNECTED, WORLD-WIDE USERS”, attorney's docket no. 12000091-0001-002, filed on even date herewith, assigned to the assignee of the present invention and incorporated herein by reference in its entirety.

Of course, many of the computers 102a-102n of distributed system 100 will be associated with users of the service for providing recommendations. Accordingly, user vectors may be stored locally at these computer systems, with each respective computer system storing the user vector(s) for one or more users associated with the respective computer system. An example of such a computer system 200 is shown in FIG. 2.

Computer system 200, upon which the above-mentioned browser extension may be installed, includes a bus 202 or other communication mechanism for communicating information, and a processor 204 coupled with the bus 202 for processing information. Computer system 200 also includes a main memory 206, such as a RAM or other dynamic storage device, coupled to the bus 202 for storing information and instructions (such as instructions comprising the browser extension software when it is running) to be executed by processor 204. Main memory 206 also may be used for storing temporary variables or other intermediate information during execution of instructions to be executed by processor 204. Computer system 200 further includes a ROM 208 or other static storage device coupled to the bus 202 for storing static information and instructions for the processor 204. A storage device 210, such as a hard disk, is provided and coupled to the bus 202 for storing information and instructions (such as instructions comprising the browser extension).

Computer system 200 may be coupled via the bus 202 to a display 212 for displaying information to a computer user. An input device 214, including alphanumeric and other keys, is coupled to the bus 202 for communicating information and command selections to the processor 204. Another type of user input device is cursor control device 216, such as a mouse, a trackball, or cursor direction keys for communicating direction information and command selections to processor 204 and for controlling cursor movement on the display 212.

Computer system 200 also includes a communication interface 218 coupled to the bus 202. Communication interface 208 provides for two-way, wired and/or wireless data communication to/from computer system 200, for example, via a local area network (LAN). Communication interface 218 sends and receives electrical, electromagnetic or optical signals which carry digital data streams representing various types of information. For example, two or more computer systems 200 may be networked together in a conventional manner with each using a respective communication interface 218.

Network link 220 typically provides data communication through one or more networks to other data devices. For example, network link 220 may provide a connection through LAN 222 to a host computer 224 or to data equipment operated by an Internet service provider (ISP) 226. ISP 226 in turn provides data communication services through the Internet 228, which, in turn, may provide connectivity to multiple remote computer systems 230a-230n (any or all of which may be similar to computer system 200). LAN 222 and Internet 228 both use electrical, electromagnetic or optical signals which carry digital data streams. Computer system 200 can send messages and receive data through the network(s), network link 220 and communication interface 218.

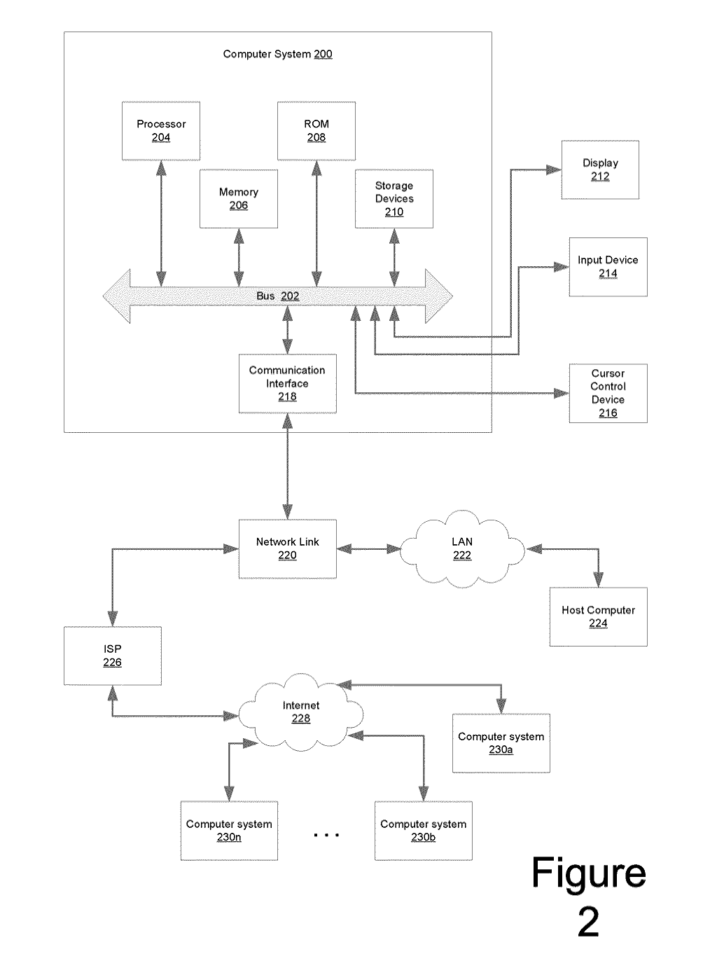

FIG. 3 illustrates the same computer system 200, this time from an architectural standpoint. In this simplified representation, the computer system includes a hardware layer 302, which is abstracted by an operating system 304. Any conventional operating system may be used. The operating system may be stored in storage device 210 and read into memory 206 when executing. Running on top of the operating system are the programs which make up the application layer 306, including a Web browser 308. As shown, the browser extension or plug-in 310, or in some cases a separate program in application layer 306, runs on computer system 200 to provide the recommendation functions described herein. Browser plug-ins and extensions are computer implemented processes integrated into a browser environment and which are capable of performing miscellaneous actions in response to user actions within the browser.

To summarize, the url_trackers (with the associated page vectors) are distributed among the user computer systems that form the distributed network at locations identified by the DHT, and when needed can be accessed in real time. Copies of the url_trackers are stored a different ones of the user computer systems to account for the fact that not all of these user computers will be accessible at all times and the copies are synchronized to reflect updates. The user vectors are stored at the respective user computers and each user computer runs an instance of the browser extension which performs the recommendation computations discussed herein. Each time a user rates (visits) a page, the corresponding user vector is obtained (using a DHT get operation) from the url_tracker responsible for the page, new vectors are computed (at the associated user computer) and the resulting page vector is sent back to the location (using a DHT put operation) where it is stored (locally or at another computer system of the distributed network). Alternatively, the updates can be performed at the computer hosting the associated url_tracker and the updated user vector and other information returned to the subject user's computer system.

Likewise, keyword_trackers are distributed among the user computer systems that form the distributed network at locations identified by the DHT, and when needed can be accessed in real time. Copies of the keyword_trackers are stored a different ones of the user computer systems to account for the fact that not all of these user computers will be accessible at all times and the copies are synchronized to reflect updates. Each time a user executes a search query, the corresponding keyword_tracker is obtained (e.g., using a DHT get operation) and the pages identified on the keyword_tracker returned. By taking the intersection of the page lists from all of the keyword_trackers involved in the response to the search query (e.g., for compound or Boolean queries), a resulting list of pages can be presented to the user.

To make recommendations, the present system locates pages similar to those which are visited by a user or which are identified in response to a search query. The recommendations may be presented via a display, such as display 212, at the user's computer system. For example, the recommendations may be displayed in a separate area of a Web page that lists search results, or may be displayed in a toolbar or other screen area associated with the browser extension discussed above.

Regardless of how the recommendations are displayed, for each page P, the K most similar pages to P are collected and displayed. In one embodiment, identifiers for the most similar pages for page P are stored on page. P's url_tracker. Of course, it is a practical impossibility to pair all possible Web pages P in order to produce and maintain sets {P₁, . . . , Pₖ} of similar pages for the entire World Wide Web, and so we propose a collection of practical approaches for doing so.

A. Matching on each visit. Each time a user M visits a page P, the computer hosting the user's user_tracker sends its K best matching pages to the computer hosting the url_tracker for page P, and the computer hosting the url_tracker for page P sends its K best matching users to the computer hosting the user_tracker for M. These functions may be performed by the respective browser extensions or other applications running on the subject computer systems. Updates are performed at each computer, accordingly. After a time, this solution should converge approximately to the situation where each user knows about his/her K most similar users and each page (url_tracker) has information concerning its K best matching pages.

B. Pairing in web history. User client programs (e.g., the browser extensions) periodically examine their respective Web histories and perform similarity measurements on each pair of pages in that history. If a measurement for a pair of pages P1 and P2 produces a result greater than a threshold value (which may be a global threshold for all pages or a page-specific threshold), this information is provided (e.g., via a put operation) to the corresponding url_trackers for the pages.

C. Pairing on keyword trackers. In this scenario, each page is tagged with one or more category tags. The tags are considered as keywords, and all pages with the same tag are listed on a common keyword_tracker. A check of all pairs of pages on each keyword_tracker (no matter if it represents a tag or a regular word) is made and if their similarity is greater than the threshold for a given page (or a global threshold for all pages), the keyword_tracker provides this information to the corresponding url_tracker

D. Routing through link structure. The Web can be modeled as an undirected graph and one can assume that similar pages are probably close to each other within such a graph. Hence, in this scheme a vector for each page P is sent to a subset of its neighbors S, from and this vector propagation continues through the graph for a few (say 2 or 3) hops. Along the path, the vector for page P is matched against vectors of the pages in the path to determine whether or not those pages should be added to the set of top K similar pages for the subject page P.

E. Dedicated trackers. Beside regular vectors with lengths of, say, 100, it is also possible to maintain much smaller vectors, containing just a few elements. These smaller vectors can be quantized and dedicated vector trackers introduced to represent them. Each url_tracker then sends its vector to the vector tracker which is most similar to small vector of subject page (which can be computed locally), and so the vector trackers associated with the small vectors will, over time, gather URLs of pages that are similar to each other.

Any or all of the above-described methods can be used collectively and/or independently of one another, thereby maximizing the opportunity to determine the exact set of K most similar pages for a subject page.

Thus, methods and systems for recommending Web pages have been described. Although discussed with reference to certain examples, the present invention should not be limited thereby. For example, the present recommendation methodologies can be used for finding recommended pages for a given user, finding similar pages to a given Web page, personalized ranking schemes, and extending a query result set with similar pages not necessarily containing query words, among other applications. Further, page vectors can be stored in a hybrid system that combines a distributed system based on a distributed hash table and a centralized system that includes multiple computers connected through a local network. Moreover, while it should be apparent from the foregoing discussion, various embodiments of the present invention may be implemented with the aid of computer-implemented processes or methods (i.e., computer programs or routines) or on any programmable or dedicated hardware implementing digital logic. Such processes may be rendered in any computer language including, without limitation, a object oriented programming language, assembly language, markup languages, and the like, as well as object-oriented environments such as the Common Object Request Broker Architecture (CORBA), Java™ and the like, or on any programmable logic hardware like CPLD, FPGA and the like.

It should also be appreciated that the portions of this detailed description were presented in terms of computer-implemented processes and symbolic representations of operations on data within a computer memory, but in all instances, the processes performed by the computer system are those requiring physical manipulations of physical quantities. The computer-implemented processes are usually, though not necessarily, embodied the form of electrical or magnetic information (e.g., bits) that is stored (e.g., on computer-readable storage media), transferred (e.g., via wired or wireless communication links), combined, compared and otherwise manipulated. It has proven convenient at times, principally for reasons of common usage, to refer to these signals as bits, values, elements, symbols, keys, numbers or the like. It should be borne in mind, however, that all of these and similar terms are to be associated with the appropriate physical quantities and are merely convenient labels applied to these quantities.

Unless specifically stated otherwise, it should be appreciated that the use of terms such as processing, computing, calculating, determining, displaying or the like, refer to the action and processes of a computer system, or similar electronic computing device, that manipulates and transforms data represented as physical (electronic) quantities within the computer system's registers, memories and other storage media into other data similarly represented as physical quantities within the computer system memories, registers or other storage media. Embodiments of the present invention can be implemented with apparatus to perform the operations described herein. Such apparatus may be specially constructed for the required purposes, or may be appropriately programmed, or selectively activated or reconfigured by a computer-readable instructions stored in or on computer-readable storage media (such as, but not limited to, any type of disk including floppy disks, optical disks, hard disks, CD-ROMs, and magnetic-optical disks, or read-only memories (ROMs), random access memories (RAMs), erasable ROMs (EPROMs), electrically erasable ROMs (EEPROMs), magnetic or optical cards, or any type of media suitable for storing computer-readable instructions) to perform the operations. Of course, the processes presented herein are not restricted to implementation through computer-readable instructions and can be implemented in appropriate circuitry, such as that instantiated in an application specific integrated circuit (ASIC), a programmed field programmable gate array (FPGA), or the like.

Thus, the invention should be measured only in terms of the claims, which follow.

1. A computer-implemented method, comprising presenting, via a Web browser running on a first computer system and to a user of the first computer system, one or more recommended Web pages, said presenting being responsive to one of the user visiting a Web site, a history of previous user visits to Web sites, or the user initiating a search query, wherein the recommended Web pages are determined by collecting, for each subject page visited by the user or each subject page identified in response to the search query, respectively, a set of Web pages deemed most similar to the subject Web site or query response, respectively, from a data structure storing information regarding each subject Web page of the set of Web pages, said data structure being stored at a location within a system that includes a plurality of computer systems, including the first computer system, communicatively coupled to one another via one of more networks, said location identified by a distributed hash table file system (DHTFS) overlaid on the plurality of computer systems and through which the plurality of computer systems store and synchronize content items among the computer systems.

2. The computer-implemented method of claim 1, wherein the data structure is stored in a system that is a hybrid of a distributed system and a centralized system that includes multiple computers connected through a local network.

3. The computer-implemented method of claim 1, wherein similarity between the subject Web site or query response and individual Web pages of the set of Web pages is estimated according to a scalar product of page vectors representing the subject Web site or query response and each respective other Web page.

4. The computer-implemented method of claim 3, wherein the page vectors are updated in response to user visits to the respective Web pages and according to maturity factors associated with each respective user that visits the respective Web page.

5. The computer-implemented method of claim 4, wherein the user visits include references by virtual users.

6. The computer-implemented method of claim 4, wherein the user visits include ratings by oracles.

7. The computer-implemented method of claim 1, wherein similarity between Web pages is assessed each time an individual user visits a page and data structures stored in the distributed system are updated to reflect the assessments.

8. The computer-implemented method of claim 1, wherein similarity between Web pages is assessed using history information regarding user browsing activities and data structures stored in the distributed system are updated to reflect the assessments.

9. The computer-implemented method of claim 1, wherein similarity between Web pages is assessed according to category information associated with each Web page.

10. The computer-implemented method of claim 9, wherein additional data structures reflecting all Web pages deemed to be in a common category are stored within the distributed system.

11. The computer-implemented method of claim 10, wherein similarity between Web pages is assessed for Web pages along routes defined within an undirected graph between the computer systems that comprise the distributed system.
